(19) United States
(12) Patent Application Publication
(10) Pub. No.: US 2026/0131292 A1
(43) Pub. Date: May 14, 2026

(54) MIXING DEVICE

(71) Applicant: Metal Industries Research & Development Centre, Kaohsiung (TW)

(72) Inventors: Kun Chieh Lin, Chiayi City (TW); Wei-Ling Ho, New Taipei City (TW); Pei-Chi Hsiao, Kaohsiung City (TW); Ssu Yun Wang, Chiayi County (TW); Ren-Wei Su, Kaohsiung City (TW); Pei-Jung Lien, Kaohsiung City (TW); Cheng-Chang Chiu, Pingtung County (TW); Lei-Chuan Lin, Kaohsiung City (TW)

(73) Assignee: Metal Industries Research & Development Centre, Kaohsiung (TW)

(21) Appl. No.: 18/945,550

(22) Filed: Nov. 13, 2024

(51) Int. Cl. B01F 23/30; B01F 101/28

(52) U.S. Cl. CPC B01F 23/39; B01F 2101/28

(57) ABSTRACT

A mixing device includes a fluid storage tank, a gas-solid mixture generator, a mixture pipeline, a mixing tank, a gas recovery tank, and a waste water tank. The fluid storage tank is configured to store fluid. The gas-solid mixture generator is communicated with the fluid storage tank to change a phase of the fluid in the fluid storage tank into a mixture of gas and solid. The mixture pipeline connects to the gas-solid mixture generator to transport the mixture. The mixing tank connects to the mixture pipeline, allowing the mixture to be transported to the mixing tank. The gas recovery tank connects to the mixture pipeline to recover gas not delivered to the mixing tank. The waste water tank is between the gas recovery tank and the mixing tank. Recovered gas flows into the waste water tank, reacts with waste water, and then flows into the mixing tank.

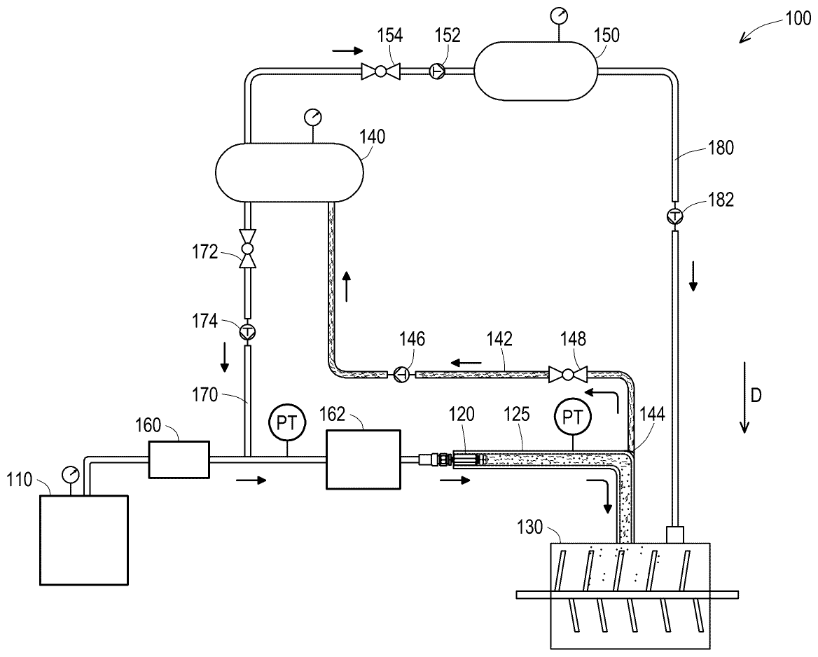

### BACKGROUND

### Technical Field

The disclosure relates to a mixing device, and more particularly, to a mixing device that may improve mixing efficiency.

### Description of Related Art

According to the information from the U.S. Energy Information Administration, a manufacturing process of cement and a manufacturing process of concrete in a cement manufactory are important sources of carbon dioxide pollution in the atmosphere. With the increasing development and industrialization of the carbon capture technology, an issue of carbon dioxide reuse has also received attention. If carbon dioxide generated during the manufacturing process may react with the concrete, a rate of carbon dioxide emission into the atmosphere may be reduced, thereby reducing an impact on the environment and improving the performance of the concrete. Therefore, how to improve mixing efficiency is a direction of research in the art.

### SUMMARY

The disclosure provides a mixing device that may improve mixing efficiency.

A mixing device in the disclosure includes a fluid storage tank, a gas-solid mixture generator, a mixture pipeline, a mixing tank, a gas recovery tank, and a waste water tank. The fluid storage tank is configured to store fluid. The gas-solid mixture generator is communicated with the fluid storage tank to change a phase of the fluid in the fluid storage tank into a mixture of gas and solid. The mixture pipeline is communicated with the gas-solid mixture generator to transport the mixture. The mixing tank is communicated with the mixture pipeline. The mixture is adapted for being transported to the mixing tank through the mixture pipeline. The gas recovery tank is communicated with the mixture pipeline to recover gas in the mixture that is not delivered into the mixing tank. The waste water tank is communicated between the gas recovery tank and the mixing tank. The gas recovered by the gas recovery tank is adapted for being introduced into the waste water tank, reacting with waste water in the waste water tank, and then flowing to the mixing tank.

In an embodiment of the disclosure, the mixing device further includes a first pump disposed between the mixture pipeline and the gas recovery tank to form a pressure drop, so that the gas in the mixture pipeline that is not delivered into the mixing tank flows to the gas recovery tank.

In an embodiment of the disclosure, the mixing device further includes a second pump disposed between the gas recovery tank and the waste water tank, so that the gas recovered by the gas recovery tank flows to the waste water tank.

In an embodiment of the disclosure, the mixing device further includes a gas recovery pipeline and a filter. The gas recovery pipeline is communicated between the mixture pipeline and the gas recovery tank. The filter is disposed at a junction of the gas recovery pipeline and the mixture pipeline.

In an embodiment of the disclosure, in a gravity direction, the mixing tank is located below the mixture pipeline, and the gas recovery tank is located above the mixture pipeline.

In an embodiment of the disclosure, the mixing device further includes a flow valve disposed between the fluid storage tank and the gas-solid mixture generator.

In an embodiment of the disclosure, the mixing device further includes a solenoid valve disposed between the fluid storage tank and the flow valve.

In an embodiment of the disclosure, the mixing device further includes a first valve disposed between the gas recovery tank and the waste water tank.

In an embodiment of the disclosure, the mixing device further includes a reintroduction pipeline, a second valve, and a pump. The reintroduction pipeline is communicated between the gas recovery tank and the gas-solid mixture generator, and the gas recovered by the gas recovery tank flows to the gas-solid mixture generator through the reintroduction pipeline. The second valve is disposed in the reintroduction pipeline. The pump is communicated with the reintroduction pipeline to pressurize the gas in the reintroduction pipeline.

In an embodiment of the disclosure, the fluid stored in the fluid storage tank is carbon dioxide. A mixture of the gas-solid mixture generator is gaseous and solid carbon dioxide. The mixing tank is a concrete mixing tank.

Based on the above, the gas-solid mixture generator of the mixing device in the disclosure is communicated with the fluid storage tank to change the phase of the fluid in the fluid storage tank into the mixture of gas and solid, and the mixture is transported to the mixing tank through the mixture pipeline. The gas-solid mixture generator may change a portion of the fluid into the solid, which may be better mixed with the material in the mixing tank to improve the mixing efficiency. In addition, the gas recovery tank of the mixing device in the disclosure is communicated with the mixture pipeline to recover the gas in the mixture that is not delivered into the mixing tank. The waste water tank is communicated between the gas recovery tank and the mixing tank. Therefore, the gas recovered in the gas recovery tank is adapted for being introduced into the waste water tank, may react with the waste water in the waste water tank, and flow to the mixing tank to be further mixed with the material in the mixing tank in a liquid form, which may improve the mixing efficiency. In addition, the gas that has not reacted with the waste water in the waste water tank also flows to the mixing tank, increasing the probability of mixing with the material in the mixing tank.

### BRIEF DESCRIPTION OF THE DRAWINGS

The FIGURE is a schematic view of a mixing device according to an embodiment of the disclosure.

### DETAILED DESCRIPTION OF DISCLOSED EMBODIMENTS

The FIGURE is a schematic view of a mixing device according to an embodiment of the disclosure. Referring to the FIGURE, a mixing device 100 in this embodiment includes a fluid storage tank 110, a gas-solid mixture generator 120, a mixture pipeline 125, a mixing tank 130, a gas recovery tank 140, and a waste water tank 150.

The fluid storage tank 110 is configured to store fluid. In this embodiment, the fluid stored in the fluid storage tank 110 is carbon dioxide, such as liquid carbon dioxide, but a type of the fluid stored in the fluid storage tank 110 is not limited thereto.

In this embodiment, the mixing device 100 further optionally includes a solenoid valve 160 and a flow valve 162. The solenoid valve 162 is disposed between the fluid storage tank 110 and the gas-solid mixture generator 120. The solenoid valve 160 is disposed between the fluid storage tank 110 and the flow valve 162. Of course, disposition positions of the solenoid valve 160 and the flow valve 162 are not limited thereto.

The solenoid valve 160 is configured to control whether the fluid stored in the fluid storage tank 110 may flow to the gas-solid mixture generator 120. The flow valve 162 is configured to control a flow rate of the fluid stored in the fluid storage tank 110 flowing to the gas-solid mixture generator 120, thereby controlling a flow velocity of a mixture of gas and solid generated by the gas-solid mixture generator 120.

The gas-solid mixture generator 120 is communicated with the fluid storage tank 110 to change a phase of the fluid in the fluid storage tank 110 into the mixture of gas and solid. In this embodiment, a mixture of the gas-solid mixture generator 120 is carbon dioxide of gas and solid, but the disclosure is not limited thereto.

The mixture pipeline 125 is communicated with the gas-solid mixture generator 120, and the mixing tank 130 is communicated with the mixture pipeline 125. The mixture of gas and solid is adapted for being transported to the mixing tank 130 through the mixture pipeline 125. In this embodiment, a pressure at the gas-solid mixture generator 120 is greater than a pressure in the mixing tank 130. Therefore, the mixture of gas and solid may be naturally transported to the mixing tank 130.

In this embodiment, the mixing tank 130 is, for example, a concrete mixing tank 130. Of course, in other embodiments, the mixing tank 130 may also accommodate other materials to be mixed. There is a mixing shaft in the mixing tank 130 to mix concrete put into the mixing tank 130. When the mixture of gas and solid is fed into the mixing tank 130, it will be stirred and mixed together with the concrete by the mixing shaft, and then solidified in the concrete.

In this embodiment, since the gas-solid mixture generator 120 may change a portion of the fluid into a solid, a mixture with solid carbon dioxide may be better mixed with the concrete in the mixing tank 130 than pure gas, thereby improving the mixing efficiency.

In addition, the gas recovery tank 140 is communicated with the mixture pipeline 125 to recover gas in the mixture that is not delivered into the mixing tank 130. The mixing device 100 further includes a gas recovery pipeline 142, and the gas recovery pipeline 142 is communicated between the mixture pipeline 125 and the gas recovery tank 140. The gas recovery pipeline 142 is optionally provided with a valve 148 to control whether the gas may flow into the gas recovery tank 140.

In this embodiment, the mixing device 100 further optionally includes a first pump 146, which is disposed between the mixture pipeline 125 and the gas recovery tank 140 to form a pressure drop in the gas recovery pipeline 142. In this way, when the valve 148 is turned on, the gas in the mixture pipeline 125 that is not delivered into the mixing tank 130 may naturally flow to the gas recovery tank 140 due to the pressure drop. Of course, in other embodiments, if the mixture in the mixture pipeline 125 has sufficient pressure and speed, the mixing device 100 may not be provided with the first pump 146.

In addition, in an embodiment, in a gravity direction D, the mixing tank 130 is located below the mixture pipeline 125, and the gas recovery tank 140 and the gas recovery pipeline 142 are located above the mixture pipeline 125. Such a design allows a heavier portion of the mixture of gas and solid in the mixture pipeline 125 (that is, the solid in the mixture) to flow downward into the mixing tank 130 together with a portion of the gas due to gravity. The gas in the mixture that is not delivered into the mixing tank 130 naturally flows to the gas recovery tank 140 through the gas recovery pipeline 142. That is to say, in the mixing device 100, the tanks or pipelines may be also disposed through a height difference to make the flow smoother, or to reduce the number of pumps and reduce costs. Of course, the configuration does not necessarily require the height difference or adding pumps to the pipeline.

In an embodiment, the mixing device 100 further includes a filter 144. The filter 144 is disposed at a junction of the gas recovery pipeline 142 and the mixture pipeline 125. Due to a large size of the solid in the mixture, the filter 144 may prevent the solid from passing through to ensure that a portion of the solid of the mixture may enter the mixing tank 130 downward and prevent the portion of the solid of the mixture from flowing to the gas recovery tank 140.

The gas recovery tank 140 is communicated with the waste water tank 150. The mixing device 100 further optionally includes a first valve 154, which is disposed between the gas recovery tank 140 and the waste water tank 150. The first valve 154 is configured to control whether the gas in the gas recovery tank 140 may flow to the waste water tank 150.

In an embodiment, if an air pressure in the gas recovery tank 140 is greater than an air pressure in the waste water tank 150, the gas in the gas recovery tank 140 may automatically flow to the waste water tank 150. In an embodiment, the mixing device 100 further optionally includes a second pump 152, which is disposed between the gas recovery tank 140 and the waste water tank 150, so that the gas recovered by the gas recovery tank 140 may flow to the waste water tank 150 more quickly.

After the gas recovered by the gas recovery tank 140 is introduced into the waste water tank 150, it may be mineralized with waste water in the waste water tank 150. The carbon mineralization technology refers to carbonation reaction of carbon dioxide, which converts carbon dioxide into calcium carbonate-stable substances. Therefore, after gaseous carbon dioxide reacts with the waste water, it may react into calcium carbonate to be mixed in the waste water.

The waste water tank 150 is communicated between the gas recovery tank 140 and the mixing tank 130, and the mineralized waste water will flow from a waste water recovery pipeline 180 to the mixing tank 130. In an embodiment, the waste water recovery pipeline 180 is optionally provided with a third pump 182, so that the mineralized waste water and the gas that has not reacted with the waste water in the waste water recovery pipeline 180 may flow to the mixing tank 130 more smoothly.

Originally, water is added for mixing when manufacturing concrete. In this case, this feature is used to add the mineralized waste water to the mixing tank 130. In addition to recovering the waste water and improving utilization of water resources, calcium carbonate in the mineralized waste water may be mixed with the concrete after being added to the mixing tank 130, and then solidified together with the concrete.

In addition, the gas (carbon dioxide) that has not reacted with the waste water in the waste water tank 150 will also flow from the waste water recovery pipeline 180 to the mixing tank 130, increasing the probability of being mixed with a material (the concrete) in the mixing tank 130. In this way, carbon dioxide generated before a manufacturing process of concrete may be recovered multiple times during the manufacturing process of concrete, reducing a rate of carbon dioxide emission into the atmosphere.

It is worth mentioning that in this embodiment, the mixing device 100 further includes a reintroduction pipeline 170. The reintroduction pipeline 170 is communicated between the gas recovery tank 140 and the gas-solid mixture generator 120. A portion of the gas recovered by the gas recovery tank 140 may flow to the gas-solid mixture generator 120 through the reintroduction pipeline 170 to form the carbon dioxide of gas and solid through the gas-solid mixture generator 120 again and enter the mixing tank 130 to be mixed with the concrete in the mixing tank 130, thereby increasing a recovery rate of carbon dioxide.

In an embodiment, a second valve 172 is disposed in the reintroduction pipeline 170, and the reintroduction pipeline 170 may be provided with a fourth pump 174. The fourth pump 174 is configured to pressurize the gas in the reintroduction pipeline 170. A combination of the second valve 172 and the fourth pump 174 may enable the gas in the gas recovery tank 140 to flow to the gas-solid mixture generator 120 more smoothly.

Generally speaking, liquid or gaseous carbon dioxide may be stored in the fluid storage tank 110 of the mixing device 100. The carbon dioxide flows to the gas-solid mixture generator 120 through the solenoid valve 160 and the flow valve 162. A portion of the carbon dioxide will form snowflake-like solid carbon dioxide, and a portion of the carbon dioxide will form gaseous carbon dioxide. The solid carbon dioxide and a portion of the gaseous carbon dioxide flow into the mixing tank 130 to be mixed with the concrete. The solid carbon dioxide may effectively increase a mixing effect with the concrete, and a portion of the gaseous carbon dioxide may be also solidified during a mixing process with the concrete. Therefore, the carbon dioxide may be effectively recovered into the concrete.

The gaseous carbon dioxide that is not delivered into the mixing tank 130 will be recovered into the gas recovery tank 140. A portion of the gaseous carbon dioxide in the gas recovery tank 140 may flow back to an original carbon dioxide supply pipeline through the reintroduction pipeline 170, and then a mixture of the carbon dioxide of gaseous and solid is generated through the gas-solid mixture generator 120 again, so as to enter the mixing tank 130 again to be mixed with the concrete. On the other hand, another portion of the gaseous carbon dioxide in the gas recovery tank 140 may be transported to the waste water tank 150 to be mineralized with the waste water, and then flow into the mixing tank 130 to be mixed with the concrete.

Therefore, the carbon dioxide generated before the manufacturing process of concrete may be well recovered during the manufacturing process of concrete, which may reduce the of carbon dioxide emission into the atmosphere causing air pollution, and achieve an effect of carbon dioxide recovery and reuse. In addition, according to practical measurements, compressive strength of the concrete mixed with the carbon dioxide is increased, and a shrinkage rate is decreased, effectively improving properties of the concrete.

Based on the above, the gas-solid mixture generator of the mixing device in the disclosure is communicated with the fluid storage tank to change the phase of the fluid in the fluid storage tank into the mixture of gas and solid, and the mixture is transported to the mixing tank through the mixture pipeline. The gas-solid mixture generator may change a portion of the fluid into the solid, which may be better mixed with the material in the mixing tank to improve the mixing efficiency. In addition, the gas recovery tank of the mixing device in the disclosure is communicated with the mixture pipeline to recover the gas in the mixture that is not delivered into the mixing tank. The waste water tank is communicated between the gas recovery tank and the mixing tank. Therefore, the gas recovered in the gas recovery tank is adapted for being introduced into the waste water tank, may react with the waste water in the waste water tank, and flow to the mixing tank to be further mixed with the material in the mixing tank in a liquid form, which may improve the mixing efficiency. In addition, the gas that has not reacted with the waste water in the waste water tank also flows to the mixing tank, increasing the probability of mixing with the material in the mixing tank.

What is claimed is:

1. A mixing device, comprising:
a fluid storage tank configured to store fluid;
a gas-solid mixture generator communicated with the fluid storage tank to change a phase of the fluid in the fluid storage tank into a mixture of gas and solid;
a mixture pipeline communicated with the gas-solid mixture generator to transport the mixture;
a mixing tank communicated with the mixture pipeline, wherein the mixture is adapted for being transported to the mixing tank through the mixture pipeline;
a gas recovery tank communicated with the mixture pipeline to recover gas in the mixture that is not delivered into the mixing tank; and
a waste water tank communicated between the gas recovery tank and the mixing tank, wherein the gas recovered by the gas recovery tank is adapted for being introduced into the waste water tank, reacting with waste water in the waste water tank, and then flowing to the mixing tank.

2. The mixing device according to claim 1, further comprising:
a first pump disposed between the mixture pipeline and the gas recovery tank to form a pressure drop such that the gas in the mixture pipeline that is not delivered into the mixing tank flows to the gas recovery tank.

3. The mixing device according to claim 1, further comprising:
a second pump disposed between the gas recovery tank and the waste water tank such that the gas recovered by the gas recovery tank flows to the waste water tank.

4. The mixing device according to claim 1, further comprising:
a gas recovery pipeline communicated between the mixture pipeline and the gas recovery tank; and
a filter disposed at a junction of the gas recovery pipeline and the mixture pipeline.

5. The mixing device according to claim 1, wherein in a gravity direction, the mixing tank is located below the mixture pipeline, and the gas recovery tank is located above the mixture pipeline.

6. The mixing device according to claim 1, further comprising:
a flow valve disposed between the fluid storage tank and the gas-solid mixture generator.

7. The mixing device according to claim 6, further comprising:
a solenoid valve disposed between the fluid storage tank and the flow valve.

8. The mixing device according to claim 1, further comprising:
a first valve disposed between the gas recovery tank and the waste water tank.

9. The mixing device according to claim 6, further comprising:
a reintroduction pipeline communicated between the gas recovery tank and the gas-solid mixture generator, wherein the gas recovered by the gas recovery tank flows to the gas-solid mixture generator through the reintroduction pipeline;
a second valve disposed in the reintroduction pipeline; and
a pump communicated with the reintroduction pipeline to pressurize the gas in the reintroduction pipeline.

10. The mixing device according to claim 1, wherein the fluid stored in the fluid storage tank is carbon dioxide, a mixture of the gas-solid mixture generator is gaseous and solid carbon dioxide, and the mixing tank is a concrete mixing tank.
